(19) United States
(12) Patent Application Publication
(10) Pub. No.: US 2013/0339576 A1
(43) Pub. Date: Dec. 19, 2013

(54) METHOD FOR CONSTRUCTING ADDRESS MAPPING TABLE OF SOLID STATE DRIVE

(71) Applicant: LITE-ON IT CORPORATION, Taipei (TW)

(72) Inventors: Chi-Kai Liu, Hsinchu (TW); Yen-Heng Chen, Hsinchu (TW)

(73) Assignee: LITE-ON IT CORPORATION, Taipei (TW)

(21) Appl. No.: 13/660,264

(22) Filed: Oct. 25, 2012

(30) Foreign Application Priority Data
Jun. 14, 2012 (CN) 201210196424.0

(51) Int. Cl. G06F 12/02; G06F 12/08

(52) U.S. Cl. 711/103; 711/E12.008; 711/E12.017

(57) ABSTRACT

A method for constructing an address mapping table of a solid state drive is provided. The address mapping table is stored in a non-volatile memory of the solid state drive. The method includes the following steps. After the solid state drive is powered on, a command from a host is received. Then, a logical allocation address is calculated according to a logical block address corresponding to the command. Then, the calculated logical allocation address is defined as an initial address, and a specified number of logical allocation addresses starting from the initial address and corresponding physical allocation addresses are loaded into a cache memory, so that a first portion of the address mapping table is constructed into the cache memory. Afterwards, the solid state drive responds the command according to the first portion of the address mapping table.

This application claims the benefit of People's Republic of China application Serial No. 201210196424.0, filed Jun. 14, 2012, the subject matter of which is incorporated herein by reference.

### FIELD OF THE INVENTION

The present invention relates to a method for constructing an address mapping table of a solid state drive, and more particularly to a method for constructing a logical-to-physical address mapping table (L2P table) of a solid state drive.

### BACKGROUND OF THE INVENTION

As is well known, a solid state drive (SSD) is a data storage device that uses a non-volatile memory to store data. After data are written to the flash memory, if the system is powered off, the data are still retained in the solid state drive.

FIG. 1 is a schematic functional block diagram illustrating a conventional solid state drive. As shown in FIG. 1, the solid state drive 10 comprises a controlling unit 101, a cache memory 107, and a non-volatile memory 105. In addition, the controlling unit 101 is in communication with a host 12 through an external bus 20. Consequently, commands and data can be exchanged between the controlling unit 101 and the host 12. Generally, the external bus 20 is a USB bus, an IEEE 1394 bus, an SATA bus, or the like.

Basically, the host 12 may access data through a logical block address (LBA). The data size corresponding to each LBA is 512 bytes. The non-volatile memory 105 accesses data through a physical allocation address (PAA). The data size corresponding to each PAA is for example 2K bytes. In other words, the data size corresponding to each PAA is four times the date size corresponding to the LBA (i.e. 2K bytes/512 bytes=4).

Moreover, a logical allocation address (LAA) is further defined by the solid state drive 10. The data size corresponding to each LAA is equal to the data size corresponding to each PAA, for example 2K bytes.

When a write command or a read command issued from the host 12 is received by the controlling unit 101, a LBA is also issued from the host 12 to indicate the address of the data to be read or written. After the LBA is received by the controlling unit 101, the LBA is converted into the corresponding LAA by the controlling unit 101. For example, if the host 12 issues LBA (X), the controlling unit 101 will divide X by 4. According to the quotient and the remainder obtained from the division, the location of the LAA corresponding to the LBA (X) and the 512-byte data corresponding to the LAA can be deduced. Take the data size corresponding to each LAA is 2K bytes for example. If the host 12 issues LBA(6), the conversion by the controlling unit 101 indicates that the data is the second 512-byte data of the LAA(1).

Moreover, for correlating the LAA with the PAA, a logical-to-physical address mapping table (L2P table) is contained in the solid state drive 10. When the host 12 issues a read command to read a data from a specified LBA of the non-volatile memory 105, the LBA is converted into the corresponding LAA by the controlling unit 101. Then, according to the L2P table, the corresponding PAA of the non-volatile memory 105 is realized, and the data is retrieved from the non-volatile memory 105 and transmitted back to the host 12.

For example, if the storage capacity of the non-volatile memory 105 is 128G bytes, there are 64 million PAAs (i.e. 128G/2K=64 million), wherein the size of each PAA registered in the L2P table is 4 bytes. Consequently, the size of the L2P table is equal to 256M bytes (i.e. 64M×4 byte=256M bytes).

FIG. 2 schematically illustrates a L2P table. The size of each PAA registered in the L2P table is 32 bits (4 bytes). In the L2P table of FIG. 2, the 64 million LAAs are defined as 00000000˜01FFFFFF in an ascending order. For example, the data size corresponding to each LAA is 2K bytes. When the host issues a read command to read the data corresponding to LBA(029ECFE0), the LBA(029ECFE0) is converted into LAA(00A7B3F8) by the controlling unit 101. According to the L2P table, the data at the PAA(012EC390) of the non-volatile memory 105 is realized, and the data is retrieved from the non-volatile memory 105 and transmitted back to the host 12

Generally, if the solid state drive 10 is normally powered on, the L2P table is stored into the cache memory 107 in order to quickly read and store the address data. Before the solid state drive 10 is powered off, the L2P table is stored into the non-volatile memory 105 by the controlling unit 101. After the solid state drive 10 is powered off, the L2P table stored in the cache memory 107 is deleted.

Since the L2P table has been stored into the non-volatile memory 105 before the solid state drive 10 is powered off, once the solid state drive 10 is powered on again, the L2P table in the non-volatile memory 105 will be stored into the cache memory 107 again by the controlling unit 101. Afterwards, the solid state drive 10 may be normally operated.

FIG. 3 is a flowchart illustrating the operations of the conventional solid state drive after the solid state drive is powered on. After the solid state drive 10 is powered on (Step S302), a command from the host 12 is received by the controlling unit 101 (Step S303). Since the L2P table has not been loaded into the cache memory 107, the solid state drive 10 fails to respond to the command.

Then, the L2P table stored in the non-volatile memory 105 should be completely loaded into the cache memory 107 by the controlling unit 101 (Step S304). If the L2P table has not been completely loaded into the cache memory 107 (Step S306), the L2P table stored in the non-volatile memory 105 is continuously loaded into the cache memory 107 by the controlling unit 101 (Step S304). Whereas, if the L2P table has been completely loaded into the cache memory 107 (Step S306), the controlling unit 101 can respond to the received command according to the L2P table in the cache memory 107.

From the above discussions, after the solid state drive 10 is powered on, the L2P table stored in the non-volatile memory 105 should be completely loaded into the cache memory 107 by the controlling unit 101, and thus the solid state drive 10 can normally read or write data. During the process of loading the L2P table, the solid state drive 10 is in a busy state. In the busy state, even if the command from the host 12 is received by the solid state drive 10, the solid state drive 10 fails to respond to the command. Until the L2P table has been completely loaded into the cache memory 107, the controlling unit 101 is able to execute the command. Moreover, the LBA corresponding to the command is converted into LAA, and the corresponding PAA is realized according to the L2P table in the cache memory 107.

However, since the data amount of the L2P table is very huge, some drawbacks occur. For example, it is time-consuming for the allowing the L2P table in the non-volatile memory 105 to be completely loaded into the cache memory 107 after the solid state drive 10 is powered on. In other words, the responding signal corresponding to the command is received by the host 12 after a long time period. Under this circumstance, the accessing efficiency of the solid state drive 10 is deteriorated.

### SUMMARY OF THE INVENTION

The present invention provides a solid state drive and a method for constructing the L2P table of the solid state drive. After the solid state drive is powered on, a portion of the L2P table can be quickly loaded into the cache memory in response to the command from the host. Consequently, the solid state drive will respond to the command according to the loaded portion of the L2P table. Furthermore, once no other command and no other data are exchanged between the host and the solid state drive, the other portion of the L2P table is continuously loaded into the cache memory.

A first embodiment of the present invention provides a solid state drive. The solid state drive includes a non-volatile memory, a cache memory, and a controlling unit. The non-volatile memory has a plurality of physical allocation addresses, wherein an address mapping table is stored in the non-volatile memory. The controlling unit is connected with the non-volatile memory and the cache memory. After the solid state drive is powered on, a logical allocation address is calculated by the controlling unit according to a command and a logical block address from a host, and a first portion of the address mapping table is loaded into the cache memory by the controlling unit according to the calculated logical allocation address.

A second embodiment of the present invention provides a method for constructing an address mapping table of a solid state drive. The solid state drive includes a non-volatile memory. The address mapping table is stored in the non-volatile memory. The method includes the following steps. After the solid state drive is powered on, a command from a host is received. Then, a logical allocation address is calculated according to a logical block address corresponding to the command. Then, the calculated logical allocation address is defined as an initial address, and a specified number of logical allocation addresses starting from the initial address and corresponding physical allocation addresses are loaded into a cache memory, so that a first portion of the address mapping table is constructed into the cache memory. Afterwards, the solid state drive responds the command according to the first portion of the address mapping table.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating a conventional solid state drive;

FIG. 2 (prior art) schematically illustrates a L2P table;

FIG. 3 (prior art) is a flowchart illustrating the operations of the conventional solid state drive after the solid state drive is powered on;

FIG. 4 is a flowchart illustrating the operations of a solid state drive of the present invention after the solid state drive is powered on; and

FIG. 5 schematically illustrates a L2P table constructed by the method of the present invention.

### DETAILED DESCRIPTION OF PREFERRED EMBODIMENTS

As previously described, after the conventional solid state drive is powered on, it takes a long time to completely load the L2P table into the cache memory. That is, it is time-consuming to respond to the command from the host. The present invention provides a solid state drive and a method for constructing the L2P table of the solid state drive. After the solid state drive is powered on, the solid state drive can quickly respond to the command. Consequently, the accessing efficiency of the solid state drive is enhanced.

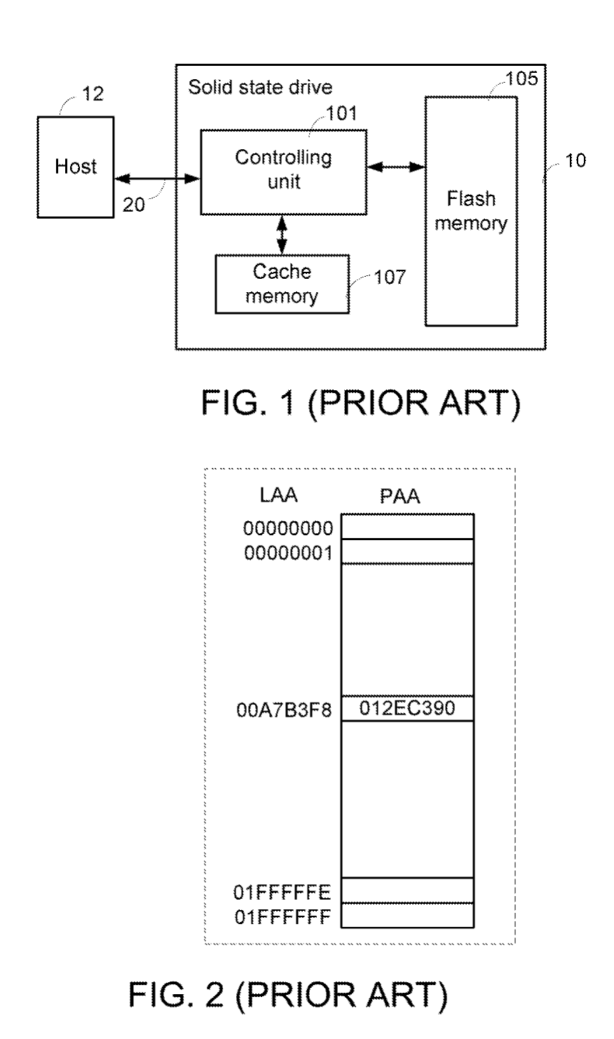

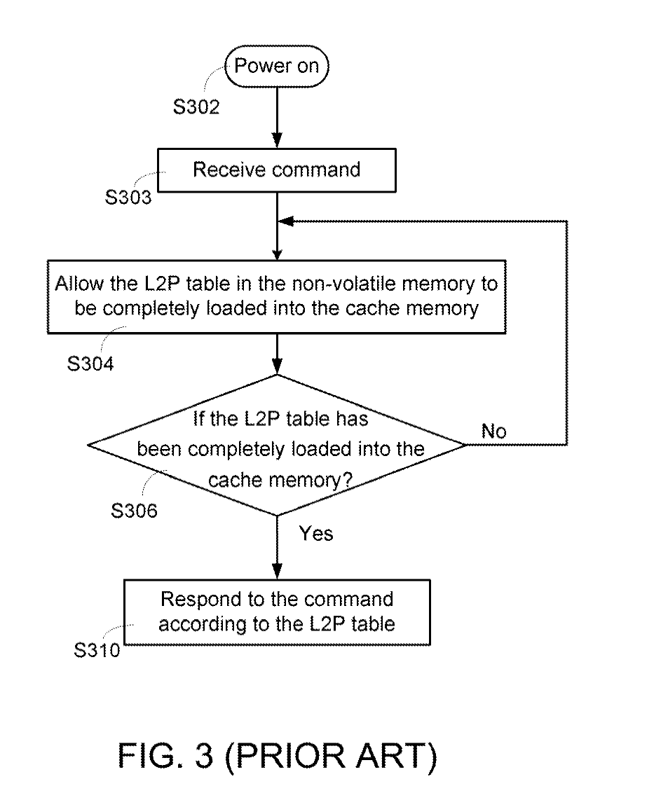

The object of the present invention is to improve the method of constructing the L2P table by the controlling unit 101. The hardware architecture of the solid state drive used in the present invention is similar to that of the solid state drive of FIG. 1, and is not redundantly described herein.

In accordance with the present invention, after the solid state drive is powered on, a portion of the L2P table can be quickly loaded into the cache memory in response to the command from the host. Consequently, the solid state drive will respond to the command according to the loaded portion of the L2P table. Furthermore, once no other command and no other data are exchanged between the host and the solid state drive, the other portion of the L2P table is continuously loaded into the cache memory.

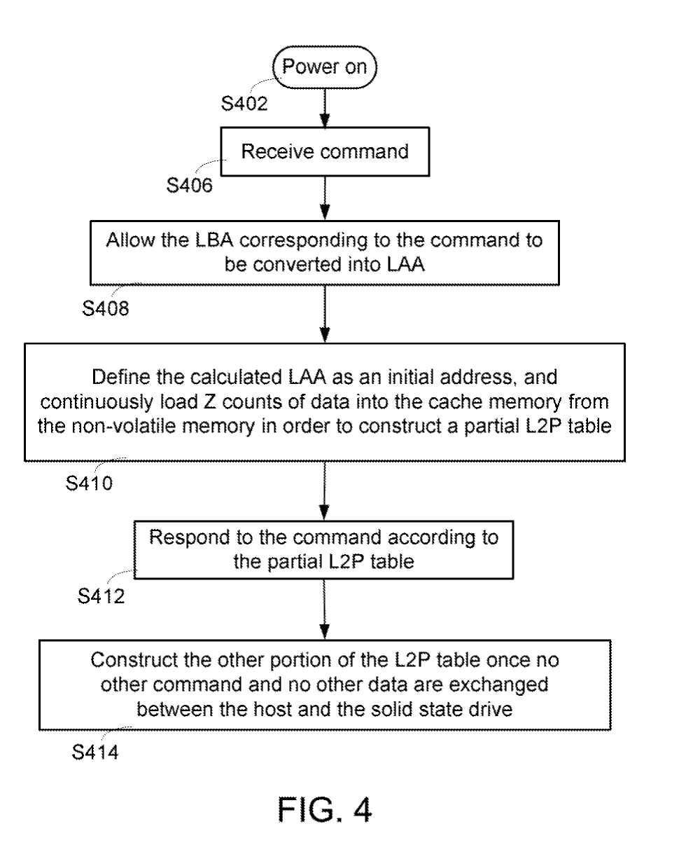

FIG. 4 is a flowchart illustrating the operations of a solid state drive of the present invention after the solid state drive is powered on. After the solid state drive 10 is powered on (Step S402), a command from the host 12 is received by the controlling unit 101 (Step S406). Consequently, the LBA corresponding to the command is converted into LAA by the controlling unit 101 (Step S408).

Then, the calculated LAA is defined as an initial address, and Z numbers of LAAs starting from the calculated LAA are continuously loaded into the cache memory 107 from the non-volatile memory 105 in order to construct a partial L2P table (Step S410). In this step, the continuous Z numbers of LAAs of the L2P table in the non-volatile memory 105 starting from the calculated LAA are loaded into the cache memory 107 by the controlling unit 101. Consequently, a portion of the L2P table is constructed in the cache memory 107. Under this circumstance, only Z counts of LAAs in the partial L2P table can be mapped into the PAAs.

Then, the controlling unit 101 responds to the received command according to the partial L2P table in the cache memory 107 (Step S412). After the controlling unit 101 responds to the received command, once no other command and no other data are exchanged between the host 12 and the solid state drive 10, the other portion of the L2P table is continuously constructed into the cache memory 107 by the controlling unit 101 (Step S414). After the controlling unit 101 responds to the received command and no other command and no other data are exchanged between the host 12 and the solid state drive 10, it means that the solid state drive 10 does not communicate with the host 12. Meanwhile, the other portion of the L2P table is constructed by the controlling unit 101.

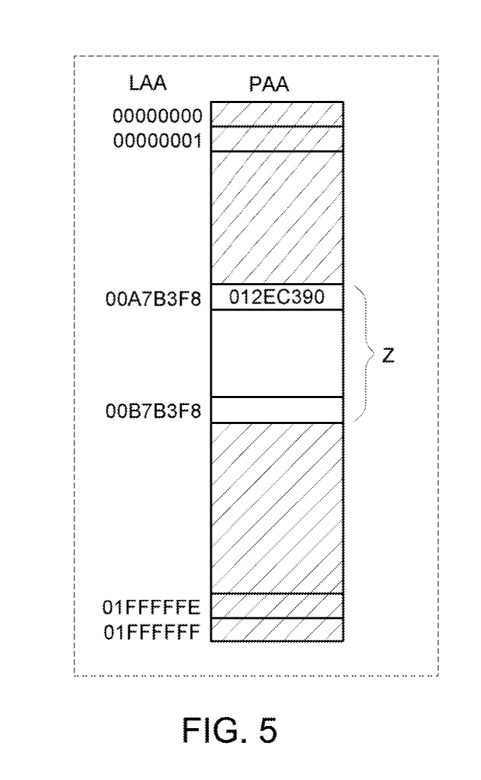

FIG. 5 schematically illustrates a L2P table constructed by the method of the present invention. The data size corresponding to each LAA is for example 2K bytes. After the solid state drive 10 is powered on, if a data corresponding to LBA(029ECFE0) from the host 12 is received by the solid state drive 10, the LBA(029ECFE0) is converted into LAA(00A7B3F8) by the controlling unit 101. Then, LAA(00A7B3F8) is defined as an initial address by the controlling unit 101. In addition, the PAA data corresponding to Z numbers of LAAs starting from the defined initial address are continuously loaded from the non-volatile memory 105 to the cache memory 107 in order to construct a partial L2P table. For example, assuming Z=1 million, the continuous 1000000 numbers of LAA data LAA(00A7B3F8)-LAA(00B7B3F8) and the corresponding PAA data are loaded into the cache memory 107. Whereas, the other portion of the L2P table (i.e. the region indicated by oblique lines) is still stored in the non-volatile memory 105, but has not been loaded into the cache memory 107.

In accordance with the present invention, before the L2P table has been completely loaded into the cache memory 107, the partial L2P table has sufficient information to respond to the received command. Consequently, the controlling unit 101 may respond to the received command according to the partial L2P table in the cache memory 107. In other words, the data is retrieved from the PAA(012EC390) of the non-volatile memory 105 and transmitted back to the host 12.

After the controlling unit 101 responds to the received command and no other command and no other data are exchanged between the host 12 and the solid state drive 10, it means that the solid state drive 10 does not communicate with the host 12. Meanwhile, the other portion of the L2P table (i.e. the region indicated by oblique lines as shown in FIG. 5) may be constructed from the non-volatile memory 105 by the controlling unit 101. Under this circumstance, the complete L2P table is constructed in the cache memory 107.

It is noted that the value of Z is not limited to 1 million. That is, the value of Z may be varied according to the practical requirements. For example, the value of Z may be in the range between 512000 and 16 million. Preferably, the value of Z is equal to 1/64˜½ of the total number of the logical allocation addresses in the L2P table. Moreover, the data size corresponding to each LAA is not limited to 2K bytes. According to the practical requirements, the convention between LBA and LAA may be adjusted.

From the above description, the present invention provides a solid state drive and a method for constructing the L2P table of the solid state drive. After the solid state drive is powered on, a portion of the L2P table can be quickly loaded into the cache memory in response to the command from the host. Consequently, the solid state drive will quickly execute the command and respond to the command according to the loaded portion of the L2P table. Moreover, once no other command and no other data are exchanged between the host and the solid state drive, the other portion of the L2P table is continuously loaded. In such way, after the solid state drive is powered on, the solid state drive can quickly respond to the command, and thus the accessing efficiency of the solid state drive is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A solid state drive, comprising:
a non-volatile memory having a plurality of physical allocation addresses, wherein an address mapping table is stored in the non-volatile memory;
a cache memory; and
a controlling unit connected with the non-volatile memory and the cache memory,
wherein after the solid state drive is powered on, a logical allocation address is calculated by the controlling unit according to a command and a logical block address from a host, and a first portion of the address mapping table is loaded into the cache memory by the controlling unit according to the calculated logical allocation address.

2. The solid state drive as claimed in claim 1, wherein once no other command and no other data are exchanged between the host and the solid state drive, a second portion of the address mapping table is loaded into the cache memory by the controlling unit.

3. The solid state drive as claimed in claim 1, wherein the calculated logical allocation address is defined as an initial address by the controlling unit, wherein a specified number of logical allocation addresses starting from the initial address and corresponding physical allocation addresses are loaded into the cache memory by the controlling unit, so that the first portion of the address mapping table is constructed.

4. The solid state drive as claimed in claim 3, wherein the specified number is equal to ⅙˜½ of a total number of the logical allocation addresses in the address mapping table.

5. The solid state drive as claimed in claim 1, wherein the address mapping table is a logical-to-physical address mapping table.

6. The solid state drive as claimed in claim 1, wherein according to the logical allocation address and the first portion of the address mapping table, the controlling unit obtains a corresponding physical allocation address and responds to the command.

7. A method for constructing an address mapping table of a solid state drive, the solid state drive comprising a non-volatile memory, the address mapping table being stored in the non-volatile memory, the method comprising steps of:
receiving a command from a host after the solid state drive is powered on;
calculating a logical allocation address according to a logical block address corresponding to the command;
defining the calculated logical allocation address as an initial address, and allowing a specified number of logical allocation addresses starting from the initial address and corresponding physical allocation addresses to be loaded into a cache memory, so that a first portion of the address mapping table is constructed into the cache memory; and
responding the command according to the first portion of the address mapping table.

8. The method as claimed in claim 7, wherein once no other command and no other data are exchanged between the host and the solid state drive, the method further comprises a step of loading a second portion of the address mapping table into the cache memory.

9. The method as claimed in claim 7, wherein the address mapping table is a logical-to-physical address mapping table.

10. The method as claimed in claim 7, wherein the specified number is equal to ⅙˜½ of a total number of the logical allocation addresses in the address mapping table.
